(19) United States
(12) Patent Application Publication
(10) Pub. No.: US 2010/0182690 A1
(43) Pub. Date: Jul. 22, 2010

(54) OPTICAL FILM, POLARIZING PLATE, AND IMAGE DISPLAY APPARATUS

(75) Inventors: Hiroyuki Takao, Osaka (JP); Tsutomu Hani, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/668,285

(22) PCT Filed: May 20, 2008
(86) PCT No.: PCT/JP2008/059199

§ 371 Date: Jan. 8, 2010

(30) Foreign Application Priority Data
Jul. 31, 2007 (JP) 2007-198454

(51) Int. Cl. G02B 1/08; C08K 5/315; C08K 5/3472; C08K 5/3492

(52) U.S. Cl. 359/485; 524/208; 524/105; 524/100

(57) ABSTRACT

Provided are an optical film which has excellent heat resistance and excellent optical transparency as well as an excellent UV-absorbing ability even in the wavelength range of 200 to 350 nm, and which is free of any defect in terms of its external appearance, a polarizing plate having a few external appearance defects and using the optical film, and an image display apparatus of high quality using the polarizing plate. The optical film of the present invention is obtained through extrusion molding of a molding material containing resin components containing a (meth)acrylic resin as a main component and 0.35 to 3.0 parts by weight of a cyanoacrylate-based UV absorber with respect to 100 parts by weight of the resin components.

### TECHNICAL FIELD

The present invention relates to an optical film, a polarizing plate using the optical film, and an image display apparatus such as a liquid crystal display apparatus, an organic EL display apparatus, or a PDP including at least one polarizing plate.

### BACKGROUND ART

A liquid crystal display apparatus must have polarizing plates arranged on both sides of a glass substrate forming the surface of a liquid crystal panel due to its image forming system. Such a polarizing plate to be used is generally manufactured by attaching a polarizer protective film on both sides of a polarizer made of a polyvinyl alcohol-based film and a dichromatic substance such as iodine by using a polyvinyl alcohol-based adhesive.

The optical film to be used as the polarizer protective film may be required to have a UV-absorbing ability for the purpose of preventing liquid crystal and the polarizer from being degraded by UV-light. Currently, a triacetyl cellulose-based film is mainly used as the polarizer protective film, and a UV absorber is added to the polarizer protective film. As a result, the polarizer protective film is provided with a UV-absorbing ability.

However, triacetyl cellulose has insufficient heat and humidity resistance and thus has a problem in that properties such as a polarization degree and a hue of a polarizing plate degrade when a polarizing plate using the triacetyl cellulose film as a polarizer protective film is used under high temperature or high humidity conditions. Further, the triacetyl cellulose film causes retardation with respect to incident light in an oblique direction. With the increase in size of a liquid crystal display in recent years, the retardation has had significant effects on viewing angle properties.

Then, as a material for the polarizer protective film that replaces conventionally used triacetyl cellulose, a (meth)acrylic resin which has high transparency and high heat resistance has been considered (see Patent Documents 1 to 3).

Investigations have been conducted on the addition of a triazine-based UV absorber or triazole-based UV absorber in order that a UV-absorbing ability may be imparted to the polarizer protective film using a (meth)acrylic resin as a main material as described above (Patent Document 4). However, when any such UV absorber is used, there arises in an extrusion molding process for film formation the problem that the UV absorber that has volatilized with the passage of time is attached to a cast roll or the like. In addition, the attached substance contaminates the film, or the shape of the attached substance is transferred onto the film. As a result, the resultant film is provided with a defect in terms of its external appearance.

In addition, when the triazine-based UV absorber or triazole-based UV absorber is used, a sufficient UV-absorbing ability may not be exerted in the wavelength range of 200 to 350 nm.

### Patent Document 1: JP 2007-52404 A

### Patent Document 2: JP 2007-41563 A

### Patent Document 3: JP 2007-25008 A

### Patent Document 4: JP 2007-17555 A

### DISCLOSURE OF THE INVENTION

### Problems to be Solved by the Invention

Objects of the present invention are (1) to provide an optical film which has not only an excellent UV-absorbing ability even in the wavelength range of 200 to 350 nm but also excellent heat resistance and excellent optical transparency and which is free of any defect in terms of its external appearance, (2) to provide a polarizing plate using the optical film and having a small number of defects in terms of its external appearance, and (3) to provide an image display apparatus of high quality using the polarizing plate.

### Means for Solving the Problems

The optical film of the present invention is obtained through extrusion molding of a molding material containing resin components containing a (meth)acrylic resin as a main component and 0.35 to 3.0 parts by weight of a cyanoacrylate-based UV absorber with respect to 100 parts by weight of the resin components.

In a preferred embodiment, a percentage by which a weight of the cyanoacrylate-based UV absorber reduces as a result of heating at 300° C. for 20 minutes is 10% or less.

In a preferred embodiment, a maximum of a light transmittance in a wavelength range of 200 to 350 nm is 7% or less.

In a preferred embodiment, a temperature of the molding material at a time of the extrusion molding is 200° C. or higher.

In a preferred embodiment, the molding material contains a triazole-based UV absorber and/or a triazine-based UV absorber.

According to another aspect of the present invention, a polarizing plate is provided. The polarizing plate of the present invention includes the optical film of the present invention as a polarizer protective film.

According to another aspect of the present invention, an image display apparatus is provided. The image display apparatus of the present invention includes at least one polarizing plate of the present invention.

### EFFECTS OF THE INVENTION

According to the present invention, there can be provided the optical film which has excellent heat resistance and excellent optical transparency as well as an excellent UV-absorbing ability even in the wavelength range of 200 to 350 nm, and which is free of any defect in terms of its external appearance, the polarizing plate having a few external appearance defects and using the optical film, and the image display apparatus of high quality using the polarizing plate.

Such effects can be achieved by obtaining the target optical film through the extrusion molding of a molding material containing resin components containing a (meth)acrylic resin as a main component and a specific amount of a cyanoacrylate-based UV absorber with respect to the resin components.

### BRIEF DESCRIPTION OF THE DRAWINGS

FIG. 1 is a cross-sectional view illustrating an example of a polarizing plate of the present invention.

FIG. 2 is a schematic cross-sectional view illustrating a liquid crystal display apparatus according to a preferred embodiment of the present invention.

Description of Symbols

| | |
|---|---|
| 10 | liquid crystal cell |
| 11, 11′ | glass substrate |
| 12 | liquid crystal layer |
| 13 | spacer |
| 20, 20′ | retardation film |
| 30, 30′ | polarizing plate |
| 31 | polarizer |
| 32 | adhesive layer |
| 33 | easy adhesion layer |
| 34 | optical film |
| 35 | adhesive layer |
| 36 | optical film |
| 40 | light guide plate |
| 50 | light source |
| 60 | reflector |
| 100 | liquid crystal display apparatus |

### BEST MODE FOR CARRYING OUT THE INVENTION

Hereinafter, description of preferred embodiments of the present invention is given, but the present invention is not limited to the embodiments.

### [A. Optical Film]

### [A-1. Resin Material]

An optical film of the present invention is obtained through the extrusion molding of a molding material containing resin components containing a (meth)acrylic resin as a main component. That is, the optical film of the present invention contains the (meth)acrylic resin as a main component.

The Tg (glass transition temperature) of the (meth)acrylic resin is preferably 115° C. or higher, more preferably 120° C. or higher, still more preferably 125° C. or higher, and particularly preferably 130° C. or higher. By including a (meth)acrylic resin having Tg (glass transition temperature) of 115° C. or higher as a main component, for example, in a case where the optical film of the present invention is incorporated in a polarizing plate as a polarizer protective film, the polarizing plate is likely to have excellent durability. The upper limit value of Tg of the above-mentioned (meth)acrylic resins is not particularly limited. However, it is preferably 170° C. or lower in view of a forming property and the like.

Any suitable (meth)acrylic resin can be used as the (meth)acrylic resin as long as the effects of the present invention are not impaired. Examples of the (meth)acrylic resin include a poly(meth)acrylate such as polymethylmethacrylate, a methyl methacrylate-(meth)acrylic acid copolymer, a methyl methacrylate-(meth)acrylate copolymer, a methyl methacrylate-acrylate-(meth)acrylic acid copolymer, a methyl (meth)acrylate-styrene copolymer (MS resin, etc.), and a polymer having an alicyclic hydrocarbon group (e.g., a methyl methacrylate-cyclohexyl methacrylate copolymer, a methyl methacrylate-norbornyl (meth)acrylate copolymer, etc.). Examples of the (meth)acrylic resin include preferably a poly(meth)acrylic C₁₋₆ alkyl such as methyl poly(meth)acrylate, and more preferably methyl methacrylate-based resin containing as a main component methyl methacrylate (50 to 100 wt %, preferably 70 to 100 wt %).

Specific examples of the (meth)acrylic resin include ACRYPET VH and ACRYPET VRL20A manufactured by Mitsubishi Rayon Co., Ltd., and a (meth)acrylic resin having high Tg obtained by intramolecular cross-linking and intramolecular cyclization reaction.

In the present invention, a (meth)acrylic resin having a glutaric anhydride structure and a (meth)acrylic resin having a lactone ring structure are each preferably used as the above (meth)acrylic resin because the resins each have high heat resistance, high transparency, and high mechanical strength.

Examples of the (meth)acrylic resin having a glutaric anhydride structure include (meth)acrylic resins each having a glutaric anhydride structure described in, for example, JP 2006-283013 A, JP 2006-335902 A, and JP 2006-274118 A.

Examples of the (meth)acrylic resin having a lactone ring structure include (meth)acrylic resins each having a lactone ring structure described in, for example, JP 2000-230016A, JP 2001-151814 A, JP 2002-120326 A, JP 2002-254544 A, and JP 2005-146084 A.

The content of the above (meth)acrylic resin in the optical film of the present invention is preferably 50 to 100 wt %, more preferably 50 to 99 wt %, still more preferably 60 to 98 wt %, or particularly preferably 70 to 97 wt %. When the content of the above (meth)acrylic resin in the optical film of the present invention is less than 50 wt %, high heat resistance and high transparency inherent in the (meth)acrylic resin may not be sufficiently reflected.

The optical film of the present invention may contain a resin component except the above (meth)acrylic resin. Any appropriate resin component can be adopted as the resin component except the above (meth)acrylic resin to such an extent that the effects of the present invention are not impaired.

The content of the above (meth)acrylic resin in the molding material used upon molding of the optical film of the present invention is preferably 50 to 100 wt %, more preferably 50 to 99 wt %, still more preferably 60 to 98 wt %, or particularly preferably 70 to 97 wt %. When the content of the above (meth)acrylic resin in the molding material used upon molding of the optical film of the present invention is less than 50 wt %, high heat resistance and high transparency inherent in the (meth)acrylic resin may not be sufficiently reflected.

The molding material used upon molding of the optical film of the present invention may contain a resin component except the above (meth)acrylic resin. Any appropriate resin component can be adopted as the resin component except the above (meth)acrylic resin to such an extent that the effects of the present invention are not impaired.

### [A-2. UV Absorber]

The optical film of the present invention is obtained through the extrusion molding of a molding material containing a UV absorber.

The optical film of the present invention necessarily contains a cyanoacrylate-based UV absorber as the above UV absorber. Any appropriate compound can be adopted as the cyanoacrylate-based UV absorber as long as the compound includes a cyanoacrylate structure represented by the following general formula (2).

### [Chem]

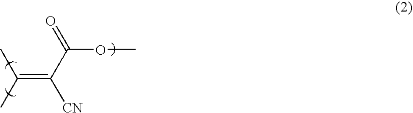

In general, a triazole-based UV absorber, a triazine-based UV absorber, or a benzophenone-based UV absorber is selected for an optical film requested to have a UV-absorbing ability in order that a light transmittance at 380 nm may be reduced. However, those UV absorbers each involve, in the process of the extrusion molding of a molding material containing the UV absorber for film formation, the problem that the UV absorber that has volatilized with the passage of time is attached to a cast roll or the like. In addition, the attached substance contaminates the film, or the shape of the attached substance is transferred onto the film. As a result, the resultant film is provided with a defect in terms of its external appearance. In addition, when any such UV absorber is used, a sufficient UV-absorbing ability may not be exerted in the wavelength range of 200 to 350 nm. In the present invention, the above problem can be solved by necessarily incorporating the cyanoacrylate-based UV absorber as a UV absorber in an amount within a specific range.

Specific examples of the above cyanoacrylate-based UV absorber include a “Uvinul3030”, a “Uvinul3035”, and a “Uvinul3039” manufactured by BASF.

In order that the effects of the present invention may be further exerted, the above cyanoacrylate-based UV absorber has a molecular weight of preferably 250 or more, more preferably 350 or more, still more preferably 500 or more, particularly preferably 750 or more, or most preferably 1,000 or more. An upper limit for the molecular weight is preferably 10,000 or less, more preferably 7,500 or less, still more preferably 5,000 or less, particularly preferably 3,000 or less, or most preferably 2,000 or less.

The above cyanoacrylate-based UV absorber is incorporated in an amount of 0.35 to 3.0 parts by weight with respect to 100 parts by weight of the resin components containing the (meth)acrylic resin as a main component. The amount is preferably 0.5 to 2.5 parts by weight or more preferably 0.7 to 2.0 parts by weight. When the above cyanoacrylate-based UV absorber is incorporated in an amount of less than 0.35 part by weight with respect to 100 parts by weight of the resin components containing the (meth)acrylic resin as a main component, its UV-absorbing ability may be insufficient. In addition, when the above cyanoacrylate-based UV absorber is incorporated in an amount of more than 3.0 parts by weight with respect to 100 parts by weight of the resin components containing the (meth)acrylic resin as a main component, the physical properties of the film or film formability may be affected. To be specific, there may arise such detrimental effect as the viscosity of the molding material at the time of its melting changes, the resin components and the UV absorber are not compatible with each other, and hence the film becomes opaque, the UV absorber volatilizes in an increased amount to contaminate a cast roll, the quantity of absorbed visible light increases to raise the yellow tint of the film, the resin components and the UV absorber are mixed so hardly at the time of their kneading as to be discharged in liquid states from a vent portion, or the flexibility of the film reduces.

The percentage by which the weight of the above cyanoacrylate-based UV absorber reduces as a result of heating at 300° C. for 20 minutes is preferably 10% or less. A method of measuring “the percentage by which the weight reduces as a result of heating at 300° C. for 20 minutes” is described later. The percentage by which the weight of the above cyanoacrylate-based UV absorber reduces as a result of heating at 300° C. for 20 minutes is preferably as small as possible. The percentage by which the weight of the above cyanoacrylate-based UV absorber reduces as a result of heating at 300° C. for 20 minutes is more preferably 9% or less, still more preferably 8% or less, particularly preferably 6% or less, or most preferably 5% or less. When such cyanoacrylate-based UV absorber that the percentage by which the weight of the UV absorber reduces as a result of heating at 300° C. for 20 minutes is more than 10% is used, its UV-absorbing ability may reduce owing to heating at the time of the molding of the optical film.

The optical film of the present invention may use any appropriate other UV absorber in combination with the cyanoacrylate-based UV absorber as the above UV absorber.

The other UV absorber is preferably, for example, at least one of a triazole-based UV absorber and a triazine-based UV absorber.

The triazole-based UV absorber preferably has a molecular weight of 400 or more. The triazine-based UV absorber preferably has a molecular weight of 400 or more.

Any appropriate triazole-based compound can be adopted as the above triazole-based UV absorber to such an extent that the objects of the present invention can be achieved. Examples of the triazole-based UV absorber include 2,2′-methylenebis[4-(1,1,3,3-tetramethylbutyl)-6-(2H-benzotriazole-2-yl)phenol], 2-(3,5-di-tert-butyl-2-hydroxyphenyl)-5-chlorobenzotriazole, 2-(2H-benzotriazole-2-yl)-p-cresol, 2-(2H-benzotriazole-2-yl)-4,6-bis(1-methyl-1-phenylethyl)phenol, 2-benzotriazole-2-yl-4,6-di-tert-butylphenol, 2-[5-chloro(2H)-benzotriazole-2-yl]-4-methyl-6-(tert-butyl)phenol, 2-(2H-benzotriazole-2-yl)-4,6-di-tert-butylphenol, 2-(2H-benzotriazole-2-yl)-4-(1,1,3,3-tetramethylbutyl)phenol, 2-(2H-benzotriazole-2-yl)-4-methyl-6-(3,4,5,6-tetrahydrophthalimidylmethyl)phenol, a reaction product of methyl 3-(3-(2H-benzotriazole-2-yl)-5-tert-butyl-4-hydroxyphenyl)propionate and polyethyleneglycol 300, and 2-(2H-benzotriazole-2-yl)-6-(linear and side chain dodecyl)-4-methylphenol.

Any appropriate triazine-based compound can be adopted as the above triazine-based UV absorber to such an extent that the objects of the present invention can be achieved. As the triazine-based UV absorber, a compound having a 1,3,5-triazine ring is preferably used, for example. Specifically, 2-(4,6-diphenyl-1,3,5-triazine-2-yl)-5-[(hexyl)oxy]-phenol and the like are exemplified.

Examples of a commercially available product include “Adekastab LA-31” (manufactured by ADEKA Corporation) as a triazole-based UV absorber and “TINUVIN 1577” (manufactured by Ciba Specialty Chemicals Inc.) as a triazine-based UV absorber.

### [A-3. Antioxidant]

The molding material used for obtaining the optical film of the present invention may contain an antioxidant for the purpose of, for example, preventing the decomposition of the resin components.

The amount of the antioxidant is, with respect to 100 parts by weight of the above resin components, preferably 0.02 part by weight or more, more preferably 0.02 to 5 parts by weight, still more preferably 0.05 to 3 parts by weight, and particularly preferably 0.1 to 2.5 parts by weight. When the amount of the antioxidant is less than 0.02 part by weight, the decomposition of resin components ((meth)acrylic resin, in particular) may be accelerated. When the amount of the antioxidant is more than 5 parts by weight, the optical properties of the optical film to be obtained may deteriorate.

The percentage by which the weight of the above antioxidant reduces as a result of heating at 300° C. for 20 minutes is preferably 10% or less. The percentage by which the weight of the above antioxidant reduces as a result of heating at 300° C. for 20 minutes is preferably as small as possible. The percentage by which the weight of the above antioxidant reduces as a result of heating at 300° C. for 20 minutes is more preferably 9% or less, still more preferably 8% or less, particularly preferably 6% or less, or most preferably 5% or less. When such antioxidant that the percentage by which the weight of the antioxidant reduces as a result of heating at 300° C. for 20 minutes is more than 10% is used, the decomposition of the resin components (the (meth)acrylic resin, in particular) is promoted at the time of the molding of the optical film, and hence foaming occurs. As a result, it may be unable to use the molded product as an optical film.

In order to express the effects of the present invention additionally, it is preferred that the antioxidant contain a phenol-based antioxidant. As the phenol-based antioxidant, any appropriate phenol-based antioxidant may be employed. Examples thereof include n-octadecyl=3-(3,5-di-t-butyl-4-hydroxyphenyl)-propionate, n-octadecyl=3-(3,5-di-t-butyl-4-hydroxyphenyl)-acetate, n-octadecyl=3,5-di-t-butyl-4-hydroxybenzoate, n-hexyl=3,5-di-t-butyl-4-hydroxyphenylbenzoate, n-dodecyl=3,5-di-t-butyl-4-hydroxyphenylbenzoate, neo-dodecyl=3-(3,5-di-t-butyl-4-hydroxyphenyl)propionate, dodecyl=β(3,5-di-t-butyl-4-hydroxyphenyl)propionate, ethyl=α-(4-hydroxy-3,5-di-t-butylphenyl)isobutylate, octadecyl=α-(4-hydroxy-3,5-di-t-butylphenyl)isobutylate, octadecyl=α-(4-hydroxy-3,5-di-t-butyl-4-hydroxyphenyl)propionate, 2-(n-octylthio)ethyl=3,5-di-t-butyl-4-hydroxy-benzoate, 2-(n-octylthio)ethyl=3,5-di-t-butyl-4-hydroxy-phenylacetate, 2-(n-octadecylthio)ethyl=3,5-di-t-butyl-4-hydroxyphenylacetate, 2-(n-octadecylthio)ethyl=3,5-di-t-butyl-4-hydroxybenzoate, 2-(2-hydroxyethylthio)ethyl=3,5-di-t-butyl-4-hydroxybenzoate, diethylglycol=bis(3,5-di-t-butyl-4-hydroxy-phenyl)propionate, 2-(n-octadecylthio)ethyl=3-(3,5-di-t-butyl-4-hydroxyphenyl)propionate, stearamide-N,N-bis-[ethylene=3-(3,5-di-t-butyl-4-hydroxyphenyl)propionate], n-butylimino-N,N-bis-[ethylene=3-(3,5-di-t-butyl-4-hydroxyphenyl)propionate], 2-(2-stearoyloxyethylthio)ethyl=3,5-di-t-butyl-4-hydroxybenzoate, 2-(2-stearoyloxyethylthio)ethyl=7-(3-methyl-5-t-butyl-4-hydroxyphenyl)heptanoate, 1,2-propyleneglycol=bis-[3-(3,5-di-t-butyl-4-hydroxyphenyl)propionate], ethylglycol=bis-[3-(3,5-di-t-butyl-4-hydroxyphenyl)propionate], neopentylglycol=bis-[3-(3,5-di-t-butyl-4-hydroxyphenyl)propionate], ethyleneglycol=bis-(3,5-di-t-butyl-4-hydroxyphenylacetate), glycerin-1-n-octadecanoate-2,3-bis-(3,5-di-t-butyl-4-hydroxyphenylacetate), pentaerythritol-tetrakis-[3-(3′,5′-di-t-butyl-4′-hydroxyphenyl) propionate], 1,1,1-trimethylolethane-tris-[3-(3,5-di-t-butyl-4-hydroxyphenyl)propionate], sorbitol hexa-[3-(3,5-di-t-butyl-4-hydroxyphenyl)propionate], 2-hydroxyethyl=7-(3-methyl-5-t-butyl-4-hydroxyphenyl)propionate, 2-stearoyloxyethyl=7-(3-methyl-5-t-butyl-4-hydroxyphenyl)heptanoate, 1,6-n-hexanediol-bis[(3′,5′-di-t-butyl-4-hydroxyphenyl)propionate], pentaerythritol-tetrakis(3,5-di-t-butyl-4-hydroxyhydrocinnamate), and 3,9-bis[1,1-dimethyl-2-[β-(3-t-butyl-4-hydroxy-5-methylphenyl) propionyloxy]ethyl]2,4,8,10-tetraoxaspiro[5,5]-undecane. As the antioxidant in which the percentage by which the weight reduces as a result of heating at 300° C. for 20 minutes is 10% or less, there are exemplified pentaerythritol-tetrakis-[3-(3′,5′-di-t-butyl-4′-hydroxyphenyl)propionate], and 3,9-bis[1,1-dimethyl-2-[β-(3-t-butyl-4-hydroxy-5-methylphenyl) propionyloxy]ethyl]2,4,8,10-tetraoxaspiro[5,5]-undecane.

In order to express the effects of the present invention additionally, it is more preferred that the antioxidant contain 0.01 part by weight or more of a phenol-based antioxidant and 0.01 part by weight or more of a thioether-based antioxidant with respect to 100 parts by weight of the resin components. It is much more preferred that the antioxidant contain 0.025 part by weight or more of the phenol-based antioxidant and 0.025 part by weight or more of the thioether-based antioxidant, and it is particularly preferred that the antioxidant contain 0.05 part by weight or more of the phenol-based antioxidant and 0.05 part by weight or more of the thioether-based antioxidant.

As the thioether-based antioxidant, any appropriate thioether-based antioxidant can be adopted. Examples thereof include pentaerythrityltetrakis(3-laurylthiopropionate), dilauryl-3,3′-thiodipropionate, dimyristyl-3,3′-thiodipropionate, and distearyl-3,3′-thiodipropionate. An example of the thioether-based antioxidant in which the percentage by which the weight reduces as a result of heating at 300° C. for 20 minutes is 10% or less includes pentaerythrityltetrakis(3-laurylthiopropionate).

In order to express the effects of the present invention additionally, it is preferred that the antioxidant contains 0.01 part by weight or more of a phenol-based antioxidant and 0.01 part by weight or more of a phosphorus-based antioxidant with respect to 100 parts by weight of the resin components. It is more preferred that the antioxidant contain 0.1 part by weight or more of the phenol-based antioxidant and 0.1 part by weight or more of the phosphorus-based antioxidant, and it is particularly preferred that the antioxidant contain 0.5 part by weight or more of the phenol-based antioxidant and 0.5 part by weight or more of the phosphorus-based antioxidant.

As the phosphorus-based antioxidant, any appropriate phosphorus-based antioxidant may be employed. Examples thereof include tris(2,4-di-t-butylphenyl)phosphite, 2-[[2,4,8,10-tetrakis(1,1-dimethylethyl)dibenzo[d,f][1,3,2]dioxaphosphepin-6-yl]oxy]-N,N-bis[2-[[2,4,8,10-tetrakis(1,1-dimethylethyl)dibenzo[d,f][1,3,2]dioxaphosphepin-6-yl]oxy]-ethyl]ethanamine, diphenyltridecylphosphite, triphenylphosphite, 2,2-methylenebis(4,6-di-t-butylphenyl)octylphosphite, bis(2,6-di-t-butyl-4-methylphenyl)pentaerythritol diphosphite, distearyl pentaerythritol diphosphite, and cyclic neopentanetetraylbis(2,6-di-t-butyl-4-methylphenyl)phosphite. As the antioxidant in which the percentage by which the weight reduces as a result of heating at 300° C. for 20 minutes is 10% or less, there is exemplified cyclic neopentanetetraylbis(2,6-di-t-butyl-4-methylphenyl)phosphite.

### [A-4. Molding Material]

The molding material used for obtaining the optical film of the present invention through extrusion molding contains the above resin components and the above cyanoacrylate-based UV absorber, and preferably further contains the above antioxidant.

The molding material to be used in the present invention may include any suitable other components to such an extent that the effects of the present invention are not impaired, and may include, for example, general compounding agents, to be specific, a stabilizer, a lubricant, a processing aid, a plasticizer, a impact-resistant aid, a retardation reducing agent, a flatting agent, an antimicrobial agent, and a fungicide.

### [A-5. Characteristics of Optical Film]

The optical film of the present invention preferably has a high light transmittance, and preferably has a low in-plane retardation Δnd a low thickness direction retardation Rth. The in-plane retardation Δnd can be obtained by Δnd=(nx−ny)×d. The thickness direction retardation Rth can be obtained by Rth=(nx−nz)×d. Herein, nx and ny are refractive indices in a plane in a slow axis direction and a fast axis direction, respectively, and nz is a thickness direction refractive index. The slow axis direction refers to a direction in which an in-plane refractive index becomes maximum.

The light transmittance at 380 nm in the thickness of 80 μm of the optical film of the present invention is preferably 15% or less, more preferably 12% or less, still more preferably 10% or less, still more preferably 8% or less, particularly preferably 6% or less, and most preferably 5% or less. When the light transmittance at 380 nm in the thickness of 80 μm of the optical film of the present invention exceeds 15%, a sufficient UV-absorbing ability may not be exhibited.

The optical film of the present invention has a maximum of a light transmittance in the wavelength range of 200 to 350 nm of preferably 7% or less, more preferably 6% or less, or still more preferably 5% or less. When the above maximum of the light transmittance is more than 7%, the wavelength of part of backlight or sunlight may damage a polarizer. When the triazine-based UV absorber or the triazole-based UV absorber is used, a sufficient UV-absorbing ability may not be exerted in the wavelength range of 200 to 350 nm. In the present invention, however, a sufficient UV-absorbing ability can be exerted even in the wavelength range of 200 to 350 nm because the cyanoacrylate-based UV absorber is necessarily used.

In the optical film of the present invention, YI in a thickness of 80 μm is preferably 1.27 or less, more preferably 1.25 or less, still more preferably 1.23 or less, and particularly preferably 1.20 or less. When the YI exceeds 1.3, excellent optical transparency may not be exhibited. Note that the YI can be obtained, for example, by the following expression based on tristimulus values (X, Y, Z) of a color obtained by measurement, using a high-speed integrating-sphere spectral transmittance meter (DOT-3C (trade name), manufactured by Murakami Color Research Laboratory Instruments).

YI=[(1.28X−1.06Z)/Y]×100

A b-value (scale of a hue in accordance with a Hunter-color system) in a thickness of 80 μm of the optical film of the present invention is preferably less than 1.5, and more preferably 1.0 or less. In the case where the b-value is 1.5 or more, excellent optical transparency may not be exhibited due to the coloring of a film. Note that the b-value can be obtained, for example, by cutting an optical film sample into pieces each having 3 cm per side and measuring the hue thereof using the high-speed integrating-sphere spectral transmittance meter (DOT-3C (trade name), manufactured by Murakami Color Research Laboratory Instruments). The hue can be evaluated based on the b-value in accordance with the Hunter-color system.

In the optical film of the present invention, an in-plane retardation Δnd is preferably 3.0 nm or less and more preferably 1.0 nm or less. When the in-plane retardation Δnd exceeds 3.0 nm, the effects of the present invention, in particular, excellent optical properties may not be exhibited. A thickness direction retardation Rth is preferably 5.0 nm or less and more preferably 3.0 nm or less. When the thickness direction retardation Rth exceeds 5.0 nm, the effects of the present invention, in particular, excellent optical properties may not be exhibited. When the optical film of the present invention is placed between the polarizer and the liquid crystal cell, the retardation is preferably within the above ranges.

In the optical film of the present invention, moisture permeability is preferably 100 g/m²·24 hr or less and more preferably 60 g/m²·24 hr or less. When the moisture permeability exceeds 100 g/m²·24 hr, moisture resistance may be degraded.

The optical film of the present invention also preferably has excellent mechanical strength. The tensile strength in an MD direction is preferably 65 N/mm² or more, more preferably 70 N/mm² or more, still more preferably 75 N/mm² or more, and particularly preferably 80 N/mm² or more. The tensile strength in a TD direction is preferably 45 N/mm² or more, more preferably 50 N/mm² or more, still more preferably 55 N/mm² or more, and particularly preferably 60 N/mm² or more. The tensile elongation in an MD direction is preferably 6.5% or more, more preferably 7.0% or more, still more preferably 7.5% or more, and particularly preferably 8.0% or more. The tensile elongation in a TD direction is preferably 5.0% or more, more preferably 5.5% or more, still more preferably 6.0% or more, and particularly preferably 6.5% or more. In the case where the tensile strength or the tensile elongation is out of the above ranges, the excellent mechanical strength may not be exhibited.

The haze representing optical transparency of the optical film of the present invention is preferably as low as possible, and is preferably 5% or less, more preferably 3% or less, and still more preferably 1.5% or less, and particularly preferably 1% or less. When the haze is 5% or less, the film can be visually provided with satisfactory clear feeling. When the haze is 1.5% or less, even if the optical film is used as a lighting member such as a window, both visibility and lighting property can be obtained, and even if the optical film is used as a front plate of a display apparatus, display contents can be visually recognized satisfactorily. Thus, the optical film has a high industrial use value.

The thickness of the optical film of the present invention is preferably 10 to 250 μm, more preferably 15 to 200 μm, still more preferably 30 to 180 μm, and particularly preferably 40 to 160 μm. When the thickness of the optical film of the present invention is 20 μm or more, the optical film has appropriate strength and rigidity, and the handling thereof becomes satisfactory during secondary processing such as lamination and printing. The retardation occurring due to the stress during take-up can be controlled easily, and hence, a film can be produced stably and easily. When the thickness of the optical film of the present invention is 200 μm or less, the take-up of a film becomes easy, and a line speed, productivity, and control property become easy.

The optical film of the present invention can be used by being laminated on another base material. For example, the optical film can also be formed to be laminated on a base material made of glass, a polyolefin resin, an ethylene vinylidene copolymer to be a high barrier layer, or a polyester and the like by multi-layer extrusion molding or multi-layer inflation molding including an adhesive resin layer. In the case where heat fusion property is high, an adhesion layer may be omitted.

The optical film of the present invention is suitable for the application as a polarizer protective film, and can be used by being laminated onto, for example, a lighting member for construction, such as a window and a carport roof member, a lighting member for a vehicle, such as a window, a lighting member for agriculture, such as a greenhouse, an illumination member, a display member such as a front filter, or the like, in addition to the application as a polarizer protective film. Further, the optical film of the present invention can also be used by being laminated onto a package of consumer electronics, an interior member in a vehicle, a construction material for an interior, a wall paper, a decorative laminate, a hallway door, a window frame, a foot stall, and the like, which are covered with a (meth)acrylic resin film conventionally.

### [A-6. Molding of Optical Film]

The optical film of the present invention is obtained through the extrusion molding of the above molding material (by a melt extrusion method such as a T-die method or an inflation method). To be specific, biaxial kneading involving the employment of direct addition or a master batch method is preferably performed. With regard to a kneading method, the kneading is preferably performed with, for example, a TEM manufactured by TOSHIBA MACHINE CO., LTD.

In the present invention, an optical film which has not only an excellent UV-absorbing ability even in the wavelength range of 200 to 350 nm but also excellent heat resistance and excellent optical transparency and which is free of any defect in terms of its external appearance can be provided by using a molding material containing resin components containing a (meth)acrylic resin as a main component and a specific amount of a cyanoacrylate-based UV absorber with respect to the resin components as a molding material upon extrusion molding as described above, and setting the light transmittance of the resultant optical film under a specific condition to a specific amount or less.

In the present invention, the effects of the present invention can be sufficiently exerted even when the temperature of the molding material upon extrusion molding is set to 200° C. or higher. Therefore, temperature setting is preferably performed so that the temperature of the molding material at the time of the extrusion molding may be 200° C. or higher in consideration of the ease with which the molding material is molded. The temperature of the molding material at the time of the extrusion molding is more preferably 200 to 300° C. or still more preferably 220 to 300° C. When the temperature excessively increases, the decomposition of the (meth)acrylic resin may be likely to proceed.

In the extrusion molding, as in a dry lamination method, it is not necessary to dry and scatter a solvent in an adhesive used during processing, e.g., an organic solvent in an adhesive for dry lamination or to perform a solvent drying step, and thus the extrusion molding is excellent in productivity.

In an exemplary preferred embodiment of a molding method for obtaining the optical film of the present invention, the optical film is obtained by adding the molding material to a biaxial kneader, extruding the molding material at a molding temperature of 200° C. or higher (more preferably 200 to 300° C. or still more preferably 220 to 300° C.) to produce a resin pellet, supplying the resultant resin pellet to a uniaxial extruder connected to a T-die, and extruding the pellet at a die temperature of 200° C. or higher (more preferably 200 to 300° C. or still more preferably 220 to 300° C.). The optical film obtained through the extrusion molding in the present invention has a thickness of preferably 20 to 250 μm, more preferably 25 to 200 μm, still more preferably 30 to 180 μm, or particularly preferably 40 to 160 μm.

The optical film of the present invention may be stretched by longitudinal stretching and/or lateral stretching.

The stretching may be stretching only by longitudinal stretching (free-end uniaxial stretching) or may be stretching only by lateral stretching (fixed-end uniaxial stretching). However, it is preferred that the stretching is sequential stretching or simultaneous biaxial stretching with a longitudinal stretching ratio of 1.1 to 3.0 times and a lateral stretching ratio of 1.1 to 3.0 times. In the stretching only by longitudinal stretching (free-end uniaxial stretching) or stretching only by lateral stretching (fixed-end uniaxial stretching), the film strength increases only in the stretching direction and the strength does not increase in a direction perpendicular to the stretching direction, with the result that sufficient film strength may not be obtained in the whole film. The longitudinal stretching ratio is preferably 1.2 to 2.5 times and more preferably 1.3 to 2.0 times. The lateral stretching ratio is more preferably 1.2 to 2.5 times and still more preferably 1.4 to 2.5 times. In the case where the longitudinal stretching ratio and the lateral stretching ratio are less than 1.1 times, the stretching ratio is too low, with the result that effects of the stretching may be hardly exhibited. When the longitudinal stretching ratio and the lateral stretching ratio exceed 3.0 times, stretching breakage is likely to occur due to the smoothness of a film end face.

The stretching temperature is preferably Tg or higher (Tg+30° C.) of a film to be stretched. When the stretching temperature is lower than Tg, the film may be broken. When the stretching temperature exceeds (Tg+30° C.), the film may start melting and feeding of paper may become difficult.

The optical film of the present invention is stretched by longitudinal stretching and/or lateral stretching, whereby the optical film has excellent optical properties and mechanical strength, and has enhanced productivity and rework property. The thickness of the stretched optical film is preferably 10 to 80 μm, and more preferably 15 to 60 μm.

### [B. Polarizing Plate]

A polarizing plate of the present invention includes the optical film of the present invention as a polarizer protective film. The polarizing plate is preferably a polarizing plate including a polarizer formed of a polyvinyl alcohol-based resin and the optical film of the present invention, the polarizer being bonded to the optical film through an adhesive layer.

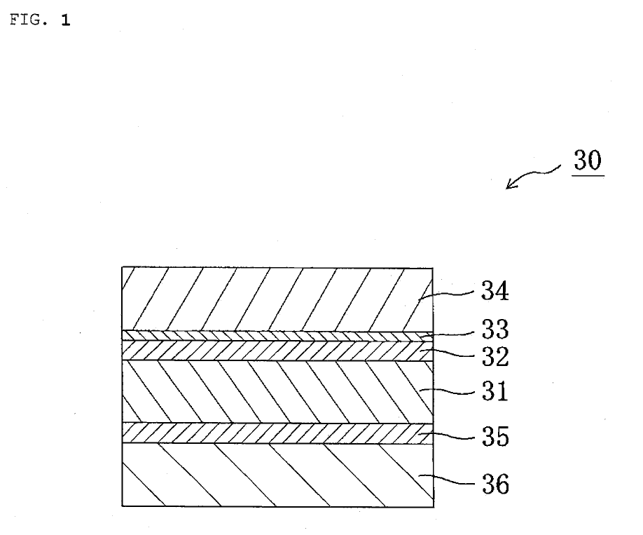

In one preferred embodiment of the polarizing plate of the present invention, as shown in FIG. 1, one surface of a polarizer 31 is bonded to an optical film 34 of the present invention via an adhesive layer 32 and an easy adhesion layer 33, and the other surface of the polarizer 31 is bonded to the optical film 36 via the adhesive layer 35. The optical film 36 may be the optical film of the present invention or any other appropriate optical film (polarizer protective film).

As the polarizer, a polarizer formed of a polyvinyl alcohol-based resin manufactured by coloring a polyvinyl alcohol-based resin film with a dichromatic substance (typically, iodine or a dichromatic dye), and uniaxially stretching the film is used. The polymerization degree of the polyvinyl alcohol-based resin for forming the polyvinyl alcohol-based resin film is preferably 100 to 5,000, and more preferably 1,400 to 4,000. The polyvinyl alcohol-based resin film for forming the polarizer may be formed by any appropriate method (such as a flow casting method involving film formation through flow casting of a solution containing a resin dissolved in water or an organic solvent, a casting method, or an extrusion method). The thickness of the polarizer may be appropriately set in accordance with the purpose and application of LCD employing the polarizing plate, but is typically 5 to 80 μm.

For producing a polarizer, any appropriate method may be employed in accordance with the purpose, materials to be used, conditions, and the like. Typically, employed is a method in which the polyvinyl alcohol-based resin film is subjected to a series of production steps including swelling, coloring, cross-linking, stretching, water washing, and drying steps. In each of the treatment steps excluding the drying step, the polyvinyl alcohol-based resin film is immersed in a bath containing a solution to be used in each step. The order, number of times, and absence or presence of swelling, coloring, cross-linking, stretching, water washing, and drying steps may be appropriately set in accordance with the purpose, materials to be used, conditions, and the like. For example, several treatments may be conducted at the same time in one step, or specific treatments may be omitted. More specifically, stretching treatment, for example, may be conducted after coloring treatment, before coloring treatment, or at the same time as swelling treatment, coloring treatment, and cross-linking treatment. Further, for example, cross-linking treatment can be preferably conducted before and after stretching treatment. Further, for example, water washing treatment may be conducted after each treatment or only after specific treatments.

The swelling step is typically conducted by immersing the polyvinyl alcohol-based resin film in a treatment bath (swelling bath) filled with water. This treatment allows washing away of contaminants from a surface of the polyvinyl alcohol-based resin film, washing away of an anti-blocking agent, and swelling of the polyvinyl alcohol-based resin film, to thereby prevent non-uniformity such as uneven coloring or the like. The swelling bath may appropriately contain glycerin, potassium iodide, or the like. The temperature of the swelling bath is typically about 20 to 60° C., and the immersion time in the swelling bath is typically about 0.1 to 10 minutes.

The coloring step is typically conducted by immersing the polyvinyl alcohol-based resin film in a treatment bath (coloring bath) containing a dichromatic substance such as iodine. As a solvent to be used for a solution of the coloring bath, water is generally used, but an appropriate amount of an organic solvent having compatibility with water may be added. The dichromatic substance is typically used in a ratio of 0.1 to 1.0 part by weight with respect to 100 parts by weight of the solvent. In the case where iodine is used as a dichromatic substance, the solution of the coloring bath preferably further contains an assistant such as an iodide for improving a coloring efficiency. The assistant is used in a ratio of preferably 0.02 to 20 parts by weight, and more preferably 2 to 10 parts by weight with respect to 100 parts by weight of the solvent. Specific examples of the iodide include potassium iodide, lithium iodide, sodium iodide, zinc iodide, aluminum iodide, lead iodide, copper iodide, barium iodide, calcium iodide, tin iodide, and titanium iodide. The temperature of the coloring bath is typically about 20 to 70° C., and the immersion time in the coloring bath is typically about 1 to 20 minutes.

The cross-linking step is typically conducted by immersing the polyvinyl alcohol-based resin film that has undergone the coloring treatment in a treatment bath (cross-linking bath) containing a cross-linking agent. The cross-linking agent employed may be any appropriate cross-linking agent. Specific examples of the cross-linking agent include: a boron compound such as boric acid or borax; glyoxal; and glutaraldehyde. The cross-linking agents may be used alone or in combination. As a solvent to be used for a solution of the cross-linking bath, water is generally used, but an appropriate amount of an organic solvent having compatibility with water may be added. The cross-linking agent is typically used in a ratio of 1 to 10 parts by weight with respect to 100 parts by weight of the solvent. In the case where a concentration of the cross-linking agent is less than 1 part by weight, sufficient optical properties are often not obtained. In the case where the concentration of the cross-linking agent is more than 10 parts by weight, stretching force to be generated on the film during stretching increases and a polarizing plate to be obtained may shrink. The solution of the cross-linking bath preferably further contains an assistant such as an iodide for obtaining uniform properties in the same plane. The concentration of the assistant is preferably 0.05 to 15 wt %, and more preferably 0.5 to 8 wt %. Specific examples of the iodide are the same as in the case with the coloring step. The temperature of the cross-linking bath is typically about 20 to 70° C., and preferably 40 to 60° C. The immersion time in the cross-linking bath is typically about 1 second to 15 minutes, and preferably 5 seconds to 10 minutes.

The stretching step may be conducted at any stage as described above. Specifically, the stretching step may be conducted after the coloring treatment, before the coloring treatment, at the same time as the swelling treatment, the coloring treatment, and the cross-linking treatment, or after the cross-linking treatment. A cumulative stretching ratio of the polyvinyl alcohol-based resin film must be 5 times or more, preferably 5 to 7 times, and more preferably 5 to 6.5 times. In the case where the cumulative stretching ratio is less than 5 times, a polarizing plate having a high polarization degree may be hard to obtain. In the case where the cumulative stretching ratio is more than 7 times, the polyvinyl alcohol-based resin film (polarizer) may easily break. A specific method of stretching employed may be any appropriate method. For example, in the case where a wet stretching method is employed, a polyvinyl alcohol-based resin film is stretched in a treatment bath (stretching bath) to a predetermined ratio. A solution of the stretching bath to be preferably used is a solution in which various metal salts or compounds of iodine, boron, or zinc are added to a solvent such as water or an organic solvent (such as ethanol).

The water washing step is typically conducted by immersing in a treatment bath (water washing bath) the polyvinyl alcohol-based resin film that has undergone the various treatments. The water washing step allows washing away of unnecessary remains from the polyvinyl alcohol-based resin film. The water washing bath may contain pure water or an aqueous solution containing iodide (such as potassium iodide or sodium iodide). The concentration of an aqueous iodide solution is preferably 0.1 to 10 mass %. The aqueous iodide solution may contain an assistant such as zinc sulfate or zinc chloride. The temperature of the water washing bath is preferably 10 to 60° C., and more preferably 30 to 40° C., and the immersion time is typically 1 second to 1 minute. The water washing step may be conducted only once, or may be conducted a plurality of times as required. In the case where the water washing step is conducted a plurality of times, the kind and concentration of the additive contained in the water washing bath to be used for each treatment may appropriately be adjusted. For example, the water washing step includes a step of immersing a polymer film in an aqueous potassium iodide solution (0.1 to 10 wt %, 10 to 60° C.) for one second to one minute and a step of washing the polymer film with pure water.

The drying step may employ any appropriate drying method (such as natural drying, air drying, or heat drying). For example, in heat drying, a drying temperature is typically 20 to 80° C., and a drying time is typically 1 to 10 minutes. In such a manner as described above, the polarizer is obtained.

The polarizing plate of the present invention is formed by bonding the polarizer to the optical film of the present invention via an adhesive layer.

In the present invention, the optical film and the polarizer are bonded to each other via an adhesive layer formed of an adhesive. The adhesive layer is preferably a layer formed of a polyvinyl alcohol-based adhesive for expressing a stronger adhesive property. The polyvinyl alcohol-based adhesive contains a polyvinyl alcohol-based resin and a cross-linking agent.

Examples of the polyvinyl alcohol-based resin include, without particular limitation: a polyvinyl alcohol obtained by saponifying polyvinyl acetate; derivatives thereof; a saponified product of a copolymer obtained by copolymerizing vinyl acetate with a monomer having copolymerizability with vinyl acetate; and a modified polyvinyl alcohol obtained by modifying polyvinyl alcohol to acetal, urethane, ether, graft, phosphate, or the like. Examples of the monomer include: unsaturated carboxylic acids such as maleic (anhydride), fumaric acid, crotonic acid, itaconic acid, and (meth)acrylic acid and esters thereof; α-olefins such as ethylene and propylene; (sodium) (meth)allylsulfonate; sodium sulfonate (monoalkylmalate); sodium disulfonate alkylmalate; N-methylol acrylamide; alkali salts of acrylamide alkylsulfonate; N-vinylpyrrolidone; and derivatives of N-vinylpyrrolidone. They may be used alone or in combination.

The polyvinyl alcohol-based resin has, from the viewpoint of an adhesive property, an average polymerization degree of preferably 100 to 3,000 and more preferably 500 to 3,000, and an average saponification degree of preferably 85 to 100 mol % and more preferably 90 to 100 mol %.

A polyvinyl alcohol-based resin having an acetoacetyl group may be used as the polyvinyl alcohol-based resin. The polyvinyl alcohol-based resin having an acetoacetyl group is a polyvinyl alcohol-based adhesive having a highly reactive functional group and is preferred from the viewpoint of improving durability of a polarizing plate.

The polyvinyl alcohol-based resin having an acetoacetyl group is obtained in a reaction between the polyvinyl alcohol-based resin and diketene through a known method. Examples of the known method include: a method involving dispersing the polyvinyl alcohol-based resin in a solvent such as acetic acid, and adding diketene thereto; and a method involving dissolving the polyvinyl alcohol-based resin in a solvent such as dimethylformamide or dioxane, in advance, and adding diketene thereto. Another example of the known method is a method involving directly bringing diketene gas or a liquid diketene into contact with polyvinyl alcohol.

A degree of acetoacetyl group modification of the polyvinyl alcohol-based resin having an acetoacetyl group is not particularly limited as long as it is 0.1 mol % or more. A degree of acetoacetyl group modification of less than 0.1 mol % provides insufficient water resistance with the adhesive layer and is inappropriate. The degree of acetoacetyl group modification is preferably 0.1 to 40 mol % and more preferably 1 to 20 mol %. A degree of acetoacetyl group modification of more than 40 mol % decreases the number of reaction sites with a cross-linking agent and provides a small effect of improving the water resistance. The degree of acetoacetyl group modification is a value measured by NMR.

As the cross-linking agent, the one used for a polyvinyl alcohol-based adhesive can be used without particular limitation. A compound having at least two functional groups each having reactivity with a polyvinyl alcohol-based resin can be used as the cross-linking agent. Examples of the compound include: alkylene diamines having an alkylene group and two amino groups, such as ethylene diamine, triethylene diamine, and hexamethylene diamine (of those, hexamethylene diamine is preferred); isocyanates such as tolylene diisocyanate, hydrogenated tolylene diisocyanate, a trimethylene propane tolylene diisocyanate adduct, triphenylmethane triisocyanate, methylene bis(4-phenylmethanetriisocyanate, isophorone diisocyanate, and ketoxime blocked compounds or phenol blocked compounds thereof; epoxies such as ethylene glycol diglycidyl ether, polyethylene glycol diglycidyl ether, glycerin di- or triglycidyl ether, 1,6-hexane diol diglycidyl ether, trimethylol propane triglycidyl ether, diglycidyl aniline, and diglycidyl amine; monoaldehydes such as formaldehyde, acetaldehyde, propione aldehyde, and butyl aldehyde; dialdehydes such as glyoxal, malondialdehyde, succinedialdehyde, glutardialdehyde, maleic dialdehyde, and phthaldialdehyde; an amino-formaldehyde resin such as a condensate of formaldehyde with methylol urea, methylol melamine, alkylated methylol urea, alkylated methylol melamine, acetoguanamine, or benzoguanamine; and salts of divalent or trivalent metals such as sodium, potassium, magnesium, calcium, aluminum, iron, and nickel and oxides thereof. A melamine-based cross-linking agent is preferred as the cross-linking agent, and methylolmelamine is particularly preferred.

A mixing amount of the cross-linking agent is preferably 0.1 to 35 parts by weight and more preferably 10 to 25 parts by weight with respect to 100 parts by weight of the polyvinyl alcohol-based resin. Meanwhile, for further improving the durability, the cross-linking agent may be mixed within a range of more than 30 parts by weight and 46 parts by weight or less with respect to 100 parts by weight of the polyvinyl alcohol-based resin. In particular, in the case where the polyvinyl alcohol-based resin having an acetoacetyl group is used, the cross-linking agent is preferably used in an amount of more than 30 parts by weight. The cross-linking agent is mixed within a range of more than 30 parts by weight and 46 parts by weight or less, to thereby improve the water resistance.

Note that the polyvinyl alcohol-based adhesive can also contain a coupling agent such as a silane coupling agent or a titanium coupling agent, various kinds of tackifiers, a UV absorber, an antioxidant, a stabilizer such as a heat-resistant stabilizer or hydrolysis-resistant stabilizer.

In the optical film of the present invention, the surface which comes into contact with a polarizer can be subjected to easy adhesion processing for the purpose of enhancing the adhesive property. Examples of the easy adhesion processing include surface treatments such as corona treatment, plasma treatment, low-pressure UV treatment, and saponification, and the formation of an anchor layer. They may be used in combination. Of those, the corona treatment, the formation of an anchor layer, and a combination thereof are preferred.

An example of the anchor layer includes a silicone layer having a reactive functional group. Examples of the material for the silicone layer having a reactive functional group are not limited to, but preferably include alkoxysilanols containing an isocyanate group, alkoxysinaols containing an amino group, alkoxysilanols containing a mercapto group, alkoxysilanols containing a carboxyl group, alkoxysilanols containing an epoxy group, alkoxysilanols containing a vinyl-type unsaturation group, alkoxysilanols containing a halogen group, and alkoxysilanols containing an isocyanate group, and amino-based silanol. The adhesive strength can be increased by adding a titanium-based catalyst and a tin-based catalyst for allowing the silanol to react efficiently. Further, another additive may be added to the silicone having a reactive functional group. Specific examples include tackifiers such as a terpene resin, a phenol resin, a terpene-phenol resin, a rosin resin, and a xylene resin, a UV-absorber, an antioxidant, and a stabilizer such as a heat-resistant stabilizer. Further, examples of the anchor layer also include a layer formed of a substance obtained by saponifying a cellulose acetate butyrate resin.

The silicone layer having a reactive functional group is formed by coating and drying in accordance with a known technology. The thickness of the silicone layer after drying is preferably 1 to 100 nm and more preferably 10 to 50 nm. During coating, silicone having a reactive functional group may be diluted with a solvent. Examples of the dilution solvent are not particularly limited, and include alcohols. The dilution concentration is not particularly limited, but is preferably 1 to 5 wt %, and more preferably 1 to 3 wt %.

The adhesive layer is formed by applying the adhesive on one side or both sides of the optical film of the present invention, or on one side or both sides of a polarizer. After the optical film of the present invention and the polarizer are attached to each other, a drying step is performed, to thereby form an adhesive layer made of an applied dry layer. After the adhesive layer is formed, the polarizer and the optical film may also be attached to each other. The polarizer and the optical film of the present invention are attached to each other with a roll laminator or the like. The heat-drying temperature and the drying time are appropriately determined depending upon the kind of an adhesive.

Too large thickness of the adhesive layer after drying is not preferred in view of the adhesive property of the optical film of the present invention. Therefore, the thickness of the adhesive layer is preferably 0.01 to 10 μm, and more preferably 0.03 to 5 μm.

The attachment of the optical film of the present invention to a polarizer can be performed by bonding both surfaces of the polarizer to one side of the optical film of the present invention.

Further, the attachment of the optical film of the present invention to a polarizer can be performed by bonding one side of the optical film of the present invention to one surface of the polarizer and attaching a cellulose-based resin to the other surface of the polarizer.

The cellulose-based resin is not particularly limited. However, triacetyl cellulose is preferred in terms of transparency and an adhesive property. The thickness of the cellulose-based resin is preferably 30 to 100 μm and more preferably 40 to 80 μm. When the thickness is smaller than 30 μm, the film strength decreases to degrade workability, and when the thickness is larger than 100 μm, the light transmittance decreases remarkably in terms of durability.

The polarizing plate of the present invention may have a pressure-sensitive adhesive layer as at least one of an outermost layer (such a polarizing plate may be referred to as polarizing plate of a pressure-sensitive adhesion type). As a particularly preferred embodiment, a pressure-sensitive adhesive layer for bonding with other members such as another optical film and a liquid crystal cell can be provided to a side of the optical film of the present invention to which the polarizer is bonded.

The pressure-sensitive adhesive forming the pressure-sensitive adhesive layer is not particularly limited. For example, a pressure-sensitive adhesive containing as a base polymer an acrylic polymer, a silicone-based polymer, polyester, polyurethane, polyamide, polyether, a fluorine or rubber-based polymer can be appropriately selected to be used. In particular, a pressure-sensitive adhesive such as an acrylic pressure-sensitive adhesive is preferably used, which is excellent in optical transparency, exhibits appropriate wettability and pressure-sensitive adhesion properties of a cohesive property and an adhesive property, and is excellent in weather resistance and heat resistance. In particular, an acrylic pressure-sensitive adhesive made of an acrylic polymer having 4 to 12 carbon atoms is preferred.

In addition to the above, in terms of the prevention of a foaming phenomenon and a peeling phenomenon caused by moisture absorption, the prevention of a degradation in optical properties and bending of a liquid crystal cell caused by thermal expansion difference or the like, and the formation property of a liquid crystal display apparatus which is of high quality and has excellent durability, a pressure-sensitive adhesive layer having a low moisture absorbing ratio and excellent heat resistance is preferred.

The pressure-sensitive adhesive layer may contain, for example, resins of a natural substance or a synthetic substance, in particular, additives to be added to the pressure-sensitive adhesive layer including a tackifying resin, a filler such as glass fibers, glass beads, metal powders, or other inorganic powders, a pigment, a colorant, and an antioxidant.

Further, a pressure-sensitive adhesive layer that contains fine particles and exhibits a light diffusion property or the like may be used.

The pressure-sensitive adhesive layer can be provided by any appropriate method. Examples thereof include a method involving preparing a pressure-sensitive adhesive solution in an amount of about 10 to 40 wt % in which a base polymer or a composition thereof is dissolved or dispersed in any appropriate single solvent such as toluene or ethyl acetate or a solvent made of a mixture, and directly providing the pressure-sensitive adhesive solution onto a polarizing plate or an optical film by any appropriate development method such as a flow casting method or a coating method, or a method involving forming a pressure-sensitive adhesive layer on a separator according to the above, and moving the pressure-sensitive adhesive layer to the polarizer protective film surface.

The pressure-sensitive adhesive layer may also be provided on one surface or both surfaces of a polarizing plate as superimposed layers of different compositions, different kinds, or the like. In the case of providing the pressure-sensitive adhesive layer on both surfaces of the polarizing plate, pressure-sensitive adhesive layers on front and reverse surfaces of the polarizing plate can have different compositions, kinds, thicknesses, and the like.

The thickness of the pressure-sensitive adhesive layer can be determined appropriately in accordance with the use purpose and the adhesive strength, and is preferably 1 to 40 μm, more preferably to 30 μm, and particularly preferably 10 to 25 μm. When the thickness of the pressure-sensitive adhesive layer is smaller than 1 μm, durability of the layer degrades. When the thickness of the pressure-sensitive adhesive layer is larger than 40 μm, lifting and peeling are likely to occur due to foaming or the like, resulting in an unsatisfactory external appearance.

In order to enhance the adhesiveness between the optical film of the present invention and the pressure-sensitive adhesive layer, an anchor layer can also be provided therebetween.

As the anchor layer, preferably, an anchor layer selected from polyurethane, polyester, and polymers containing amino groups in molecules is used, and in particular, the polymers containing amino groups in molecules are preferably used. In the polymer containing an amino group in molecules, an amino group in the molecules reacts or exhibits an interaction such as an ion interaction, with a carboxyl group in the pressure-sensitive adhesive or a polar group in a conductive polymer, and hence, satisfactory adhesiveness is ensured.

Examples of the polymers containing amino groups in molecules include polyethyleneimine, polyallylamine, polyvinylamine, polyvinylpyridine, polyvinylpyrrolidine, and a polymer of an amino group-containing monomer such as dimethylaminoethyl acrylate shown in the copolymerized monomer of the acrylic pressure-sensitive adhesive.

In order to provide the anchor layer with an antistatic property, an antistatic agent can also be added. Examples of the antistatic agent for providing an antistatic property include an ionic surfactant, conductive polymers such as polyaniline, polythiophene, polypyrrole, and polyquinoxaline, and metal oxides such as tin oxide, antimony oxide, and indium oxide. In particular, in view of optical properties, an external appearance, an antistatic effect, and stability of an antistatic effect under heat or humidification, the conductive polymers are used preferably. Of those, a water-soluble conductive polymer such as polyaniline and polythiophene, or a water-dispersion conductive polymer is particularly preferably used. The reason for this is that, in the case of using a water-soluble conductive polymer or a water-dispersion conductive polymer as a material for forming an antistatic layer, the deterioration of an optical film base material caused by an organic solvent can be suppressed in the process of application.

In the present invention, each layer of a polarizer, and an optical film (a polarizer protective film or the like), and the pressure-sensitive adhesive layer each forming the polarizing plate may be provided with a UV-absorbing ability, for example, by the treatment with a UV absorber such as a salicylate-based compound, a benzophenol-based compound, benzotriazol-based compound, a cyanoacrylate-based compound, and a nickel complex salt-based compound.

The polarizing plate of the present invention may be provided on one of a viewer side and a backlight side of a liquid crystal cell or on both sides thereof without particular limitation.

### [C. Image Display Apparatus]

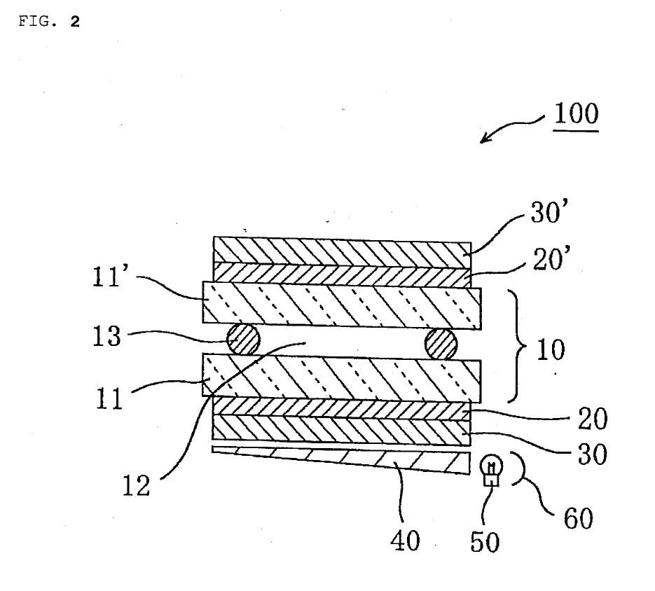

Next, an image display apparatus of the present invention is described. The image display apparatus of the present invention includes at least one polarizing plate of the present invention. Herein, as one example, a liquid crystal display apparatus is described. However, it is needless to say that the present invention is applicable to any display apparatus requiring a polarizing plate. Specific examples of the image display apparatus to which the polarizing plate of the present invention is applicable include a self-emitting display apparatus such as an electroluminescence (EL) display, a plasma display (PD), and a field emission display (FED). FIG. 2 is a schematic cross-sectional view of a liquid crystal display apparatus according to a preferred embodiment of the present invention. In the illustrated example, a transmission-type liquid crystal display apparatus is described. However, it is needless to say that the present invention is also applicable to a reflection-type liquid crystal display apparatus or the like.

A liquid crystal display apparatus 100 includes a liquid crystal cell 10, retardation films 20 and 20′ placed so as to interpose the liquid crystal cell 10 therebetween, polarizing plates 30 and 30′ placed on outer sides of the retardation films 20 and 20′, a light guide plate 40, a light source 50, and a reflector 60. The polarizing plates 30 and 30′ are placed so that polarization axes thereof are perpendicular to each other. The liquid crystal cell 10 includes a pair of glass substrates 11 and 11′ and a liquid crystal layer 12 as a display medium placed between the substrates. One glass substrate 11 is provided with a switching element (typically, TFT) for controlling the electrooptical properties of liquid crystals, a scanning line for providing a gate signal to the switching element, and a signal line for providing a source signal to the switching element (all of them are not shown). The other glass substrate 11′ is provided with a color layer forming a color filter and a shielding layer (black matrix layer) (both of them are not shown). A distance (cell gap) between the glass substrates 11 and 11′ is controlled by a spacer 13. In the liquid crystal display apparatus of the present invention, the polarizing plate of the present invention described above is employed as at least one of the polarizing plates 30 and 30′.

For example, in the case of the liquid crystal display apparatus 100 employing a TN mode, liquid crystal molecules of the liquid crystal layer 12 are aligned in a state with respective polarization axes being shifted by 90° during no voltage application. In such a state, incident light including light in one direction transmitted through the polarizing plate is twisted 90° by the liquid crystal molecules. As described above, the polarizing plates are arranged such that the respective polarization axes are perpendicular to each other, and thus light (polarized light) reaching the other polarizing plate transmits through the polarizing plate. Thus, during no voltage application, the liquid crystal display apparatus 100 provides a white display (normally white mode). Meanwhile, in the case where a voltage is applied onto the liquid crystal display apparatus 100, alignment of the liquid crystal molecules in the liquid crystal layer 12 changes. As a result, the light (polarized light) reaching the other polarizing plate cannot transmit through the polarizing plate, and a black display is provided. Displays are switched as described above by pixel by using the active element, to thereby form an image.

### EXAMPLES

Hereinafter, the present invention is described specifically with reference to examples, but the present invention is not limited to the examples. Unless otherwise noted, “%” in the examples and comparative examples refers to “wt %”. Evaluations were performed as follows.

### <Evaluation Method of UV-Absorbing Ability>

The obtained optical film was measured for the light transmittance at 380 nm and the light transmittance in a wavelength range of 200 to 350 nm by using Hitachi spectrophotometer U-4100 manufactured by Hitachi High-Technologies Corporation.

### <Weight Reduction as a Result of Heating at 300° C. for 20 Minutes>

The weight reduction as a result of heating at 300° C. for 20 minutes was evaluated based on the weight reduction rate in the case of heating at 300° C. for 20 minutes in a nitrogen stream. The weight reduction was measured in a nitrogen stream by a thermogravimetric analysis apparatus (TG/DTA6200 manufactured by Seiko Instruments Inc.) using about 5 to 10 mg of a sample. The sample was raised in temperature to 300° C. at 10° C./min and held at 300° C. for 20 minutes. The weight reduction was calculated by the following Expression:

M=(M1−M0)/M0

where M0 is the weight before processing, M1 is the weight after the processing, and M is the weight reduction rate (%).

### <Contamination of Cast Roll>

The state of a cast roll was visually observed after a lapse of 1 hour in a state where the film was transported along the cast roll in a film-forming method not based on such a mode that the film was sandwiched between rolls except the cast roll on the cast roll immediately on the heels of a T-die in extrusion.

∘: The cast roll maintains an original state.
Δ: An attached substance is slightly observed.
x: An attached substance is deposited in a significant amount to clearly have an adverse effect on the external appearance of the film.

### <Evaluation of Polarizing Plate for External Appearance>

A pressure-sensitive adhesive type polarizing plate was cut into a shape measuring 25 mm by 50 mm. After that, a releasing film was peeled and attached to a glass plate through a pressure-sensitive adhesive layer. Thus, an evaluation sample was obtained. The sample was loaded into a UV Long-Life Fade Meter (manufactured by Suga Test Instruments Co., Ltd., model: U48HB) and irradiated with ultraviolet light for 240 hours. After the irradiation, the sample was taken out and visually evaluated for its external appearance.

∘: The sample shows no change as compared to its initial state.
x: The sample shows a change in its color as compared to its initial state.

### Reference Example 1

### Production of Polarizer

A polyvinyl alcohol film with a thickness of 80 μm was dyed in a 5 wt % iodine aqueous solution (weight ratio: iodine/potassium iodide=1/10). Then, the resultant polyvinyl alcohol film was immersed in an aqueous solution containing 3 wt % of boric acid and 2 wt % of potassium iodide. Further, the polyvinyl alcohol film was stretched by 5.5 times in an aqueous solution containing 4 wt % of boric acid and 3 wt % of potassium iodide, and thereafter, the polyvinyl alcohol film was immersed in a 5 wt % potassium iodide aqueous solution. After that, the polyvinyl alcohol film was dried in an oven at 40° C. for 3 minutes to obtain a polarizer with a thickness of 30 μm.

### Example 1

First, 1.2 parts by weight of a cyanoacrylate-based UV absorber (Uvinul3030 manufactured by BASF, molecular weight=1,060), 3.5 parts by weight of a triazole-based UV absorber (Adekastab LA-31 manufactured by ADEKA Corporation), 1 part by weight of a phosphorus-based antioxidant (PEP-36 manufactured by ADEKA Corporation), and 1 part by weight of a phenol-based antioxidant (IRGANOX1010 manufactured by Ciba Specialty Chemicals) with respect to 100 parts by weight of an acrylic resin pellet (“ACRYPET VH” manufactured by Mitsubishi Rayon Co., Ltd.) were prepared. Then, the materials were mixed in a biaxial kneader at 220° C. Thus, a resin pellet was produced.

The percentages by which the weight of each of the additives used reduced as a result of heating at 300° C. for 20 minutes were the cyanoacrylate-based UV absorber (Uvinul3030 manufactured by BASF, molecular weight=1,060)=0.4%, the triazole-based UV absorber (Adekastab LA-31 manufactured by ADEKA Corporation)=2.8%, the phosphorus-based antioxidant (PEP-36 manufactured by ADEKA Corporation)=7.9%, and the phenol-based antioxidant (IRGANOX1010 manufactured by Ciba Specialty Chemicals)=4.2%.

The resultant resin pellet was dried at 100.5 kPa and 100° C. for 12 hours. The dried product was extruded from a T-die in a uniaxial extruder at a die temperature of 230° C. Further, the extruded product was stretched with a tenter stretching apparatus at 135° C. on the basis of a simultaneous biaxial mode at a ratio of 1.9 in its longitudinal direction and at a ratio of 1.9 in its lateral direction. Thus, an optical film (1) having a thickness of 30 μm was produced.

Table 1 shows the results of the evaluations.

### Example 2

First, 1.2 parts by weight of a cyanoacrylate-based UV absorber (Uvinul3035 manufactured by BASF, molecular weight=297), 3.5 parts by weight of a triazole-based UV absorber (Adekastab LA-31 manufactured by ADEKA Corporation), 1 part by weight of a phosphorus-based antioxidant (PEP-36 manufactured by ADEKA Corporation), and 1 part by weight of a phenol-based antioxidant (IRGANOX1010 manufactured by Ciba Specialty Chemicals) with respect to 100 parts by weight of an acrylic resin pellet (“ACRYPET VH” manufactured by Mitsubishi Rayon Co., Ltd.) were prepared. Then, the materials were mixed in a biaxial kneader at 220° C. Thus, a resin pellet was produced.

The percentages by which the weight of each of the additives used reduced as a result of heating at 300° C. for 20 minutes were the cyanoacrylate-based UV absorber (Uvinul3035 manufactured by BASF, molecular weight=297)≧50%, the triazole-based UV absorber (Adekastab LA-31 manufactured by ADEKA Corporation)=2.8%, the phosphorus-based antioxidant (PEP-36 manufactured by ADEKA Corporation)=7.9%, and the phenol-based antioxidant (IRGANOX1010 manufactured by Ciba Specialty Chemicals)=4.2%.

The resultant resin pellet was dried at 100.5 kPa and 100° C. for 12 hours. The dried product was extruded from a T-die in a uniaxial extruder at a die temperature of 230° C. Further, the extruded product was stretched with a tenter stretching apparatus at 135° C. on the basis of a simultaneous biaxial mode at a ratio of 1.9 in its longitudinal direction and at a ratio of 1.9 in its lateral direction. Thus, an optical film (2) having a thickness of 30 μm was produced.

Table 1 shows the results of the evaluations.

### Example 3

First, 1.2 parts by weight of a cyanoacrylate-based UV absorber (Uvinul3039 manufactured by BASF, molecular weight=361), 3.5 parts by weight of a triazole-based UV absorber (Adekastab LA-31 manufactured by ADEKA Corporation), 1 part by weight of a phosphorus-based antioxidant (PEP-36 manufactured by ADEKA Corporation), and 1 part by weight of a phenol-based antioxidant (IRGANOX1010 manufactured by Ciba Specialty Chemicals) with respect to 100 parts by weight of an acrylic resin pellet (“ACRYPET VH” manufactured by Mitsubishi Rayon Co., Ltd.) were prepared. Then, the materials were mixed in a biaxial kneader at 220° C. Thus, a resin pellet was produced.

The percentages by which the weight of each of the additives used reduced as a result of heating at 300° C. for 20 minutes were the cyanoacrylate-based UV absorber (Uvinul3039 manufactured by BASF, molecular weight=361)≧50%, the triazole-based UV absorber (Adekastab LA-31 manufactured by ADEKA Corporation)=2.8%, the phosphorus-based antioxidant (PEP-36 manufactured by ADEKA Corporation)=7.9%, and the phenol-based antioxidant (IRGANOX1010 manufactured by Ciba Specialty Chemicals)=4.2%.

The resultant resin pellet was dried at 100.5 kPa and 100° C. for 12 hours. The dried product was extruded from a T-die in a uniaxial extruder at a die temperature of 230° C. Further, the extruded product was stretched with a tenter stretching apparatus at 135° C. on the basis of a simultaneous biaxial mode at a ratio of 1.9 in its longitudinal direction and at a ratio of 1.9 in its lateral direction. Thus, an optical film (3) having a thickness of 30 μm was produced.

Table 1 shows the results of the evaluations.

### Comparative Example 1

First, 3.5 parts by weight of a triazole-based UV absorber (Adekastab LA-31 manufactured by ADEKA Corporation), 1 part by weight of a phosphorus-based antioxidant (PEP-36 manufactured by ADEKA Corporation), and 1 part by weight of a phenol-based antioxidant (IRGANOX1010 manufactured by Ciba Specialty Chemicals) with respect to 100 parts by weight of an acrylic resin pellet (“ACRYPET VH” manufactured by Mitsubishi Rayon Co., Ltd.) were prepared. Then, the materials were mixed in a biaxial kneader at 220° C. Thus, a resin pellet was produced.

The percentages by which the weight of each of the additives used reduced as a result of heating at 300° C. for 20 minutes were the triazole-based UV absorber (Adekastab LA-31 manufactured by ADEKA Corporation)=2.8%, the phosphorus-based antioxidant (PEP-36 manufactured by ADEKA Corporation)=7.9%, and the phenol-based antioxidant (IRGANOX1010 manufactured by Ciba Specialty Chemicals)=4.2%.

The resultant resin pellet was dried at 100.5 kPa and 100° C. for 12 hours. The dried product was extruded from a T-die in a uniaxial extruder at a die temperature of 230° C. Further, the extruded product was stretched with a tenter stretching apparatus at 135° C. on the basis of a simultaneous biaxial mode at a ratio of 1.9 in its longitudinal direction and at a ratio of 1.9 in its lateral direction. Thus, an optical film (Cl) having a thickness of 30 μm was produced.

Table 1 shows the results of the evaluations.

TABLE 1

| | Cyanoacrylate-based | | | | | | |
|---|---|---|---|---|---|---|---|
| | UV absorber | | | | | Wavelength at | |
| | | | Percentage by | | | which maximum | |
| | | | which weight | | | of light | |
| | | | reduces as a | | Maximum of light | transmittance | |
| | | | result of | Light | transmittance in | in wavelength | |
| | | | heating at | transmittance at | wavelength range | range of 200 to | |
| | | Molecular | 300° C. for 20 | 380 nm | of 200 to 350 nm | 350 nm appears | Contamination |
| | Kind | weight | minutes | (%) | (%) | (nm) | of cast roll |
| Example 1 | Uvinul | 1,060 | 0.4% | 7 | 2.0 | 256 | ◯ |
| | 3030 | | | | | | |
| Example 2 | Uvinul | 297 | 50% or more | 7 | 2.1 | 256 | Δ |
| | 3035 | | | | | | |
| Example 3 | Uvinul | 361 | 50% or more | 7 | 2.2 | 256 | Δ |
| | 3039 | | | | | | |
| Comparative | — | — | — | 7 | 8.5 | 272 | ◯ |
| Example 1 | | | | | | | |

### Example 4

### Adhesive

An aqueous solution of a polyvinyl alcohol-based adhesive was prepared by adjusting a concentration of an aqueous solution containing 20 parts by weight of methylol melamine and 100 parts by weight of a polyvinyl alcohol resin modified with acetoacetyl groups (acetylation degree: 13%) to 0.5 wt %.

### (Production of Polarizing Plate)

The optical film (1) obtained in Example 1 was attached to both surfaces of the polarizer obtained in Reference Example 1 using a polyvinyl alcohol-based adhesive. The polyvinyl alcohol-based adhesive was applied onto acrylic resin surface sides. Then, the resultant was dried at 70° C. for 10 minutes, to obtain a polarizing plate.

### (Pressure-Sensitive Adhesive)

As a base polymer, a solution (solid content: 30%) containing an acrylic polymer with a weight average molecular weight of 2,000,000 made of a copolymer of butyl acrylate:acrylic acid:2-hydroxyethyl acrylate=100:5:0.1 (weight ratio) was used. To the acrylic polymer solution, 4 parts of COLONATE L manufactured by Nippon Polyurethane Co., Ltd., which was an isocyanate-based polyfunctional compound, 0.5 part of an additive (KBM 403 manufactured by Shin-Etsu Chemical Co., Ltd.), and a solvent (ethyl acetate) for adjusting the viscosity were added with respect to 100 parts of a polymer solid content, to thereby prepare the pressure-sensitive adhesive solution (solid content: 12%). The pressure-sensitive adhesive solution was applied onto a releasing film (polyethylene terephthalate base material: Dia Foil MRF38 manufactured by Mitsubishi Chemical Polyester Film Co., Ltd.) so that the thickness of the layer was 25 μm after drying, followed by drying in a hot-air circulation type oven, to thereby form a pressure-sensitive adhesive layer.

### (Polarizing Plate Anchor Layer)

A polyethyleneimine adduct of polyacrylate (Polyment NK380 manufactured by Nippon Shokubai Co., Ltd.) was diluted 50-fold with methylisobutylketone. The resultant polyethyleneimine adduct was applied onto a nylon resin side of the polarizing plate using a wire bar (#5) so that the thickness after drying was 50 nm, followed by drying.

### (Production of Pressure-Sensitive Adhesive Type Polarizing Plate)

A releasing film with the pressure-sensitive adhesive layer formed thereon was attached to the polarizing plate anchor layer, to thereby produce a pressure-sensitive adhesive type polarizing plate.

### (Evaluation of Polarizing Plate)

The adhesive property between the film and the polarizer of the obtained polarizing plate, and the external appearance thereof were evaluated. It was revealed that the adhesive property was favorable and the polarizer and the film were integrated with each other and did not peel from each other, and the evaluation result of the external appearance was “∘”.

### INDUSTRIAL APPLICABILITY

The optical film and the polarizing plate of the present invention can be preferably used for various kinds of image display apparatuses (liquid crystal display apparatus, organic EL display apparatus, PDP, etc.).

1. An optical film obtained through extrusion molding of a molding material containing resin components containing a (meth)acrylic resin as a main component and 0.35 to 3.0 parts by weight of a cyanoacrylate-based UV absorber with respect to 100 parts by weight of the resin components.

2. An optical film according to claim 1, wherein a percentage by which a weight of the cyanoacrylate-based UV absorber reduces as a result of heating at 300° C. for 20 minutes is 10% or less.

3. An optical film according to claim 1 or 2, wherein a maximum of a light transmittance in a wavelength range of 200 to 350 nm is 7% or less.

4. An optical film according to claim 3, wherein a temperature of the molding material at a time of the extrusion molding is 200° C. or higher.

5. An optical film according to claim 4, wherein the molding material contains a triazole-based UV absorber and/or a triazine-based UV absorber.

6. A polarizing plate comprising the optical film according to claim 5 as a polarizer protective film.

7. An image display apparatus comprising at least one of the polarizing plates according to claim 6.
